(19) United States
(12) Patent Application Publication
(10) Pub. No.: US 2013/0200186 A1
(43) Pub. Date: Aug. 8, 2013

(54) PAPER SHREDDER WITH THERMO-REGULATED MOTOR

(71) Applicants: John F. O'Rourke, Irvine, CA (US); Erick P. Wolf, Corona Del Mar, CA (US); Kevin Chen, Palos Verdes, CA (US); Chung Shih Tsai, Hawthorne, CA (US)

(72) Inventors: John F. O'Rourke, Irvine, CA (US); Erick P. Wolf, Corona Del Mar, CA (US); Kevin Chen, Palos Verdes, CA (US); Chung Shih Tsai, Hawthorne, CA (US)

(21) Appl. No.: 13/366,065

(22) Filed: Feb. 3, 2012

(51) Int. Cl. B02C 23/00; H02K 9/00; H02K 9/22

(52) U.S. Cl. 241/33; 310/52; 310/53

(57) ABSTRACT

A paper shredder with a thermo-regulated motor, a universal motor, and a method for cooling a motor. Paper shredder includes a shredder mechanical assembly and a thermo-regulated motor with motor stator core housing, coupled to the shredder mechanical assembly. Thermo-regulated motor includes conductive stay secured to housing. Conductive band and conductive stay act to dissipate motor heat. Thermoelectric cooler is coupled to the conductive band; and insulative stay is secured to the housing with a conductive band. Thermoelectric cooler continues to cool the housing after the motor is deenergized. A universal motor having conductive stays and insulative stays physically coupled to the housing; and one conductive band securing the insulative stays and conductive stays to the housing. The universal motor can include thermoelectric coolers. Also, a method for cooling a motor, which includes providing a conductive band and providing a conductive stay interposed between the conductive band and the housing.

### BACKGROUND

1. Field of the Invention

The present embodiments relate to the field of paper shredders, and more particularly, cooled shredder motors.

2. Background Art

A duty cycle includes an ON period during which a motor is electrically ON, followed by an OFF period during which electricity to the motor is turned off. Generally, OFF time exceeds ON time, particularly in consumer products like shredders, because well-known motor Joule heating losses and relatively inefficient electro-mechanical conversions of electric power to mechanical power, is manifested as accumulated heat. Heat is detrimental to the longevity and the efficiency of an electric motor, degrading motor stator core insulation and stator coil insulation, causing insulator aging, and leading to other causes of early motor failures, if not mitigated. In many instances, motors experience a 3-5% (or greater) failure rate, largely due to electrical element failures. Use of a thermocooler device (Peltier) directly upon the motor may cause undesirable warping of the stator housing. Most often, the solution to heat concerns centers around “more motor”—using a larger motor, unless the application itself calls for motor custom thermal modeling. In consumer devices, such as paper shredders, it may be impractical to custom model each motor for an application, or too expensive to buy a larger motor.

### SUMMARY

The present embodiments include a paper shredder with a thermo-regulated motor, a universal motor, and a method for cooling a motor. The paper shredder includes a shredder mechanical assembly configured to comminute material such as sheets of paper; and a thermo-regulated motor with a motor stator core housing, where the thermo-regulated motor is coupled to the shredder mechanical assembly. The thermo-regulated motor is configured to urge the shredder mechanical assembly to comminute the sheets of paper. The thermo-regulated motor includes at least one thermal conductive stay secured to the periphery of the motor stator core housing with a thermal conductive band in which the thermal conductive band and thermal conductive stay act to dissipate motor thermal heat. In some embodiments a thermoelectric cooler is thermally coupled to the thermal conductive band; and a thermal insulative stay may be secured to the motor stator core housing with a thermal conductive band and set apart from the thermal conductive stay. In addition, a plurality of thermal conductive stays can be secured to the motor stator core housing with a thermal conductive band and set apart from the thermal insulative stay. Another embodiment of the paper shredder includes a plurality of the thermal insulative stays; a plurality of the thermal conductive stays set apart from the thermal insulative stays, in which the plurality of thermal insulative stays and the plurality of thermal conductive stays are secured to the motor stator core housing with the thermal conductive band to dissipate motor thermal heat. The embodiment also can be configured to include a thermoelectric cooler thermally coupled to the thermal conductive band to provide cooling to the motor stator core housing, and a thermoelectric cooler controller coupled to the thermoelectric cooler and configured to vary cooling provided by the thermoelectric cooler to the motor stator core housing in response to motor thermal heat or other factors, including load.

Other embodiments of the paper shredder can be configured with a plurality of thermoelectric coolers; and a thermoelectric cooler controller coupled to the plurality of thermoelectric coolers and configured to vary cooling provided by the plurality of thermoelectric coolers to the motor stator core housing in response to motor thermal heat or other factors, including load. At least one thermal sensor can be coupled to the thermoelectric cooler controller and to the motor stator core housing to transmit a motor thermal heat signal representative of heat in the motor stator core housing to the thermoelectric cooler controller. In selected embodiments the thermoelectric cooler has a heat-dissipating side and wherein at least one of the plurality of thermoelectric coolers has a thermal fin thermally coupled to the respective heat-dissipating side. In some of the embodiments, the thermo-regulated motor has a duty cycle of at least 25%. In some embodiments, the thermoelectric cooler continues to cool the motor stator core housing after the motor is deenergized. In yet other embodiments, the paper shredder can be configured with an activation circuit disposed to activate the thermo-regulated motor in the presence of material to be shredded (shreddant). The paper shredder embodiments also can include a power regulation circuit, disposed to regulate power to at least one of the thermo-regulated motor, the shredder controller, and the thermoelectric cooler controller. In selected ones of embodiments the motor is operated by an alternating current, which may be a pulse-width modulated. In selected others of embodiments, the motor can be operated by a direct current.

Embodiments presently include a universal motor having a motor rotor; a motor stator core housing enclosing the rotor; at least two coils of wires in opposition to the other and, when energized, electromechanically active on the motor rotor; at least two set apart thermally conductive stays thermally coupled to the motor stator core housing; at least two set apart thermally insulative stays physically coupled to the motor stator core housing alternatingly in-between the at least two set apart thermally conductive stays; and at least one conductive band securing the insulative stays to and thermally coupling the conductive stays to the motor stator housing core. Embodiments of the universal motor can include a plurality of thermoelectric coolers secured and thermally coupled on the at least one conductive band and respectively disposed in the proximity of the at least two set apart thermally insulative stays.

Present embodiments also include a method for cooling a motor, which includes providing a thermal conductive band around a motor stator core housing; providing a thermal conductive stay thermally interposed between the thermal conductive band and the motor stator core housing; providing a thermal insulative stay thermally interposed between the thermal conductive band and the motor stator core housing and set apart from the thermal conductive stay; and providing cooling to the motor stator core housing responsive to providing the thermal conductive band and providing the thermal conductive stay thermally interposed between the thermal conductive band and the motor stator core housing. Some embodiments also include providing a thermoelectric cooler on the conductive band in proximity to the thermal insulative stay; sensing a motor stator core housing temperature; and controlling in response motor stator core housing temperature by operating the thermoelectric cooler thermally coupled to the thermally conductive band thermally coupled to the thermally conductive stays.

### BRIEF DESCRIPTION OF THE DRAWINGS

Embodiments of the present invention disclosed herein are illustrated by way of example, and are not limited by the accompanying figures, in which like references indicate similar elements, and in which:

FIG. 1 is an example cross-section of a shredder body, including a motor, in accordance with the teachings of the present invention;

FIG. 2 is an example side perspective view of a universal motor, which is an element of FIG. 1, in accordance with the teachings of the present invention

FIG. 3 is a motor cross-section through section lines III of FIG. 2, without rotor, in accordance with the teachings of the present invention;

FIG. 4A is an example of a conductive stay held to a motor stator housing by a conductive band, in accordance with the teachings of the present invention;

FIG. 4B is an example of a insulative stay held to a motor stator housing by a conductive band, in accordance with the teachings of the present invention;

FIG. 5 is a motor cross-section through section lines III of FIG. 2, without rotor, including a thermoelectric cooler and controller, in accordance with the teachings of the present invention;

FIG. 6 is a block diagram of a shredder and motor controller using a conductive stay held to a motor stator housing by a conductive band, in accordance with the teachings of the present invention;

Skilled artisans can appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE EMBODIMENTS

The present embodiments describe apparatus and methods by which to mitigate motor overheating, insulator failure and aging, and poor duty cycle ratings. Present embodiments are presented in the context of a paper shredder, although other appliances may benefit. Similarly, present embodiments are presented in the context of a universal motor, although other motors may benefit, mutatis mutandi. An embodiment presented herein includes a thermo-regulated motor coupled to a shredder mechanical assembly, an activation circuit, and a power regulation circuit. The activation circuit can include a mechanical switch or a permittivity-controlled activator located in a feed throat proximate to the shredder blade assembly. The power regulator circuit regulates electrical power to the electrical motor, activation circuit, and operative indicators. The thermo-regulated motor can include an electric motor, a conduction band, at least one conductive stay interposed between the electric motor and the conduction band, in which the conduction band makes thermal contact with at least one heat-producing section of the electric motor. The embodiment also can include a thermoelectric cooler coupled to the conductive band and removing heat from at least one heat-producing section of the electric motor. An insulative stay may be positioned between the conduction band and the electric motor in a predetermined spaced-apart relationship with the at least one conductive stay. Heat from the thermo-regulated motor can be removed by the thermally conductive stays thermally coupled to the motor stator core housing. One or more thermoelectric coolers may be thermally coupled to the thermally conductive band to further augment cooling effects to the motor.

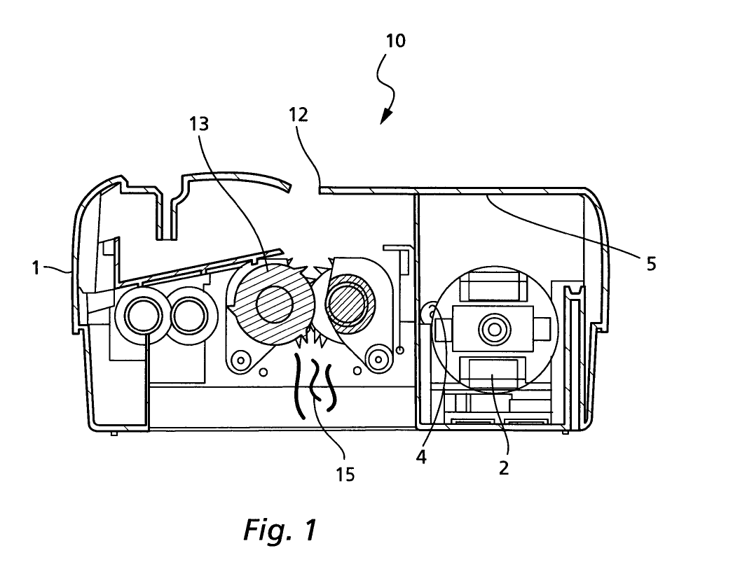

FIG. 1 generally illustrates a paper shredder, generally at 10. Paper shredder 10 can include shredder body 1, shredder motor 2, housed in body 1, shredder mechanical assembly 13, mechanically coupled by gear train 4 to shredder motor 2. Motor 2 can be covered by upper shroud member 5. Shredder 10 typically intakes a preselected number of shreddant sheets, comminutes the sheets, and ejects the shredded material 15 therefrom, typically into a waste bin. For economical and pragmatic reasons, shredder motor 2 is limited in size and power, and is generally sufficient to accomplish complete comminution of a preselected number of sheets at a time (capacity) and per preselected unit of run time (ON-OFF duty cycle). A typical capacity for a shredder may be 8-12 sheets and a typical duty time (as a percentage of total time) may be as low as 4-10%. By using thermo-regulated motor 2, the preselected number of sheets for comminution may be increased, the ON part of the duty cycle may be extended, or both. Generally, insulator aging can be decreased and the life-span of a thermo-regulated motor can be extended relative to typical motors. A longer life-span and greater reliability can lead to greater customer satisfaction with the product.

“Thermo-regulation” and its variants, as meant herein, pertain to regulation of the heat produced through various shredder motor mechanical, electrical, and electromechanical processes, exclusive of motor temperature cut-out mechanisms. Regulation may be by removing heat by use of a thermal conductive stay and a thermal conduction band or of a thermal conductive stay and a thermal conduction band in conjunction with use of thermoelectric cooling devices thermally coupled to the conductive band. Regulation also may be effected by selective use of plural thermally conductive stays, one or more non-thermally-conductive (insulative) stays, or both, placed, for example, between the conductive band and the stator core housing.

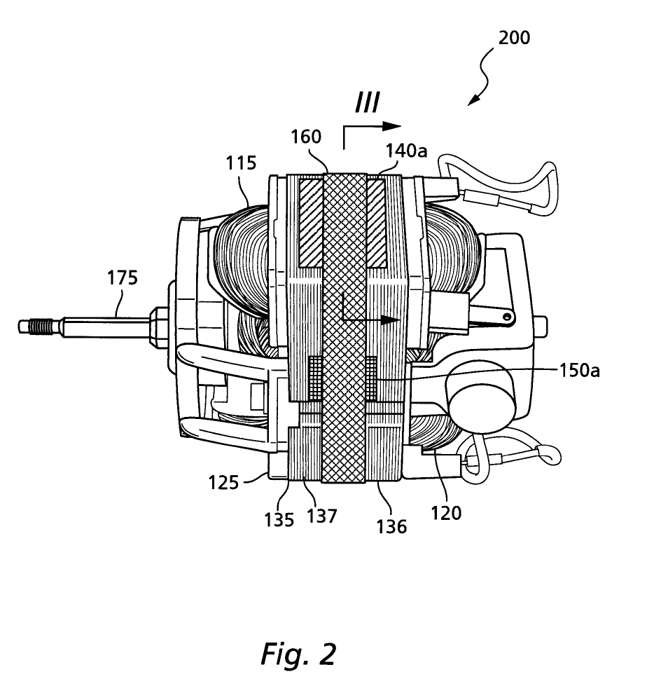

FIG. 2 illustrates a thermo-regulated shredder motor 200, similar to motor 2, in the form of a universal motor, having a motor stator core housing 135, upper stator windings (coil) 115, lower stator windings (coil) 120, motor frame 125, and rotor 165. Motor 200 can be an implementation of motor 2 in FIG. 1. Although a universal-type motor is shown, the teachings herein may be modified for use on other types of direct current (DC) and alternating current (AC) motors. A typical motor employs metallic laminations 136 joined to form a motor stator core housing 135. Within motor stator core housing 135 are disposed upper stator coil 115 and lower stator coil 120, each typically formed from many meters of thin, copper wire, coiled to produce a desired electromagnetic field and causing rotation of stator 175 with sufficient force to cause paper comminution, when used in a shredder. The construction and other elements of universal-type motor are well-known to those of ordinary skill in the electrical motor arts, and existing features of such motors may be drawn from the knowledge of the field.

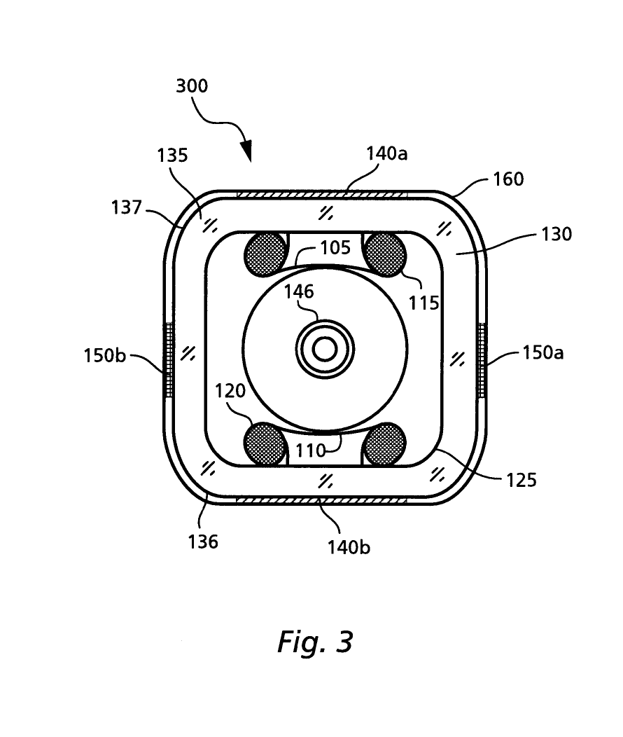

Thermo-regulated motor 200 includes thermally conductive (and electrically insulative) band 160 secured around the periphery of motor stator core housing 135. Between band 160 and housing 135 are located stays 140a, b and 150a, b. Stays 140b and 150b are not shown due to the present vantage of the FIG. 2, but are visible in FIG. 3. Stays can be in the form of conductive or insulative pads held tightly against the surface of motor stator core housing 135 using conductive band 160. Section III through housing 135 of motor 200 corresponds to the drawing of FIG. 3, containing motor cross-section 300. In present embodiments, stays 140a, 140b can be conductive stays and stays 150a, 150b can be insulative stays. A conductive stay (e.g., 140a) is electrically insulative but thermally conductive, and assists in conducting thermal energy (heat) from motor stator core housing to conductive strap 160. An insulative stay (e.g., 150a) can be both thermally and electrically insulative. Section III of FIG. 2 is illustrated as motor cross section 300 as FIG. 3.

In FIG. 3, Section III of FIG. 2 represents cross-section 300 of motor 200, motor stator core housing 135 also is shown to include stator housing core 130 and stator housing inner cavity 125. Motor stator core housing 135 typically consists of laminations of thermally conductive metal, generally at 136, perpendicular to the rotor 146 axis and joined together to provide an effective electromagnetic environment to drive the mechanical load (not shown). Within cavity 125 are disposed the motor rotor 146, upper winding stanchion 105, upper wiring coil 115, lower winding stanchion 110, and lower wiring coil 120. A strong, synchronized rotating electromagnetic field in each of coil 115 and 120 is used to effect motor rotor 146 cyclical rotational movement which, in turn, provides the mechanical power of motor rotational energy to a load (for example, a shredder assembly 13 in FIG. 1). During the conversion of electrical energy to mechanical energy, inefficiencies in the form of heat are generated within coils 115, 120. This thermal energy is, in turn, transmitted to upper stanchion 105, lower stanchion 110, motor stator core housing 135, and finally the peripheral surface (periphery) 137 of motor stator core housing 135.

It may be desirable to remove heat from motor stator core housing 135, particularly in low or intermittent duty devices with occasional high current draws, such as a paper shredder. An example existing paper shredder may be rated for 10 minutes of operation and 120 minutes of cooling—with the duty cycle (8%) configured primarily directed to maintaining a reasonable longevity of the shredder motor 200 by prolonged periods of cooling. To shorten the off-time and to prolong the rated on-time, without more, can be an invitation to early motor dysfunction or outright failure. Thermo-regulation can permit more rugged duty for even simple universal motors.

The electromagnetic motor according to the present embodiments may have at least one conductive stay 140a, 140b approximately positioned over and in thermal contact with at least one of upper coil 115 or lower coil 120. In selected embodiments, conductive stay 140a may be positioned in proximity with upper coil 115 and conductive stay 140b may be positioned in proximity with lower coil 120. The thermal energy generated by the corresponding coil 115, 120 may be transmitted for additional dissipation along conduction band 160 in the general direction of insulative stay 150a, 150b, positioned at about 90 degrees apart from conductive stays 140a, 140b. Embodiments can include at least one insulative stay generally narrowly set apart from a conductive stay to provide a thermally-insulated region in general proximity to a conductive stay. In another embodiment, insulative stays 150a, 150b can each be disposed about 90 degrees from each of upper coil 115 and lower coil 120. Insertion of at least one insulative stay 150a, 150b, which may be physically smaller (or larger) in area than a conductive stay, can provide physical or thermal stabilization to the remaining structure.

In certain embodiments, partial U or O-shaped cooling structures can be added by cooling strap 160 via conductive stays 150a, 150b. As understood, using at least one conductive stay and perhaps an insulative stay, roughly 90 or 180 degrees apart can provide a larger surface area for heat dissipation from one of upper coil 115, lower coil 120, or both. In FIG. 3, a configuration of conductive stays and insulative stays is depicted in which a conductive stay 140a, alternates at 90 degrees with insulative stay 150a, which is followed by a conductive stay 140b, and then by a second insulative stay 150b in a 12-3-6-9 o'clock arrangement, generally held in proximity to motor stator core housing 135 by conductive band 160. Of course, other configurations can be efficacious. In addition, conductive stays 140a, 140b are depicted as being and may be measurably larger than insulative stays 150a, 150b, although this is not a prerequisite.

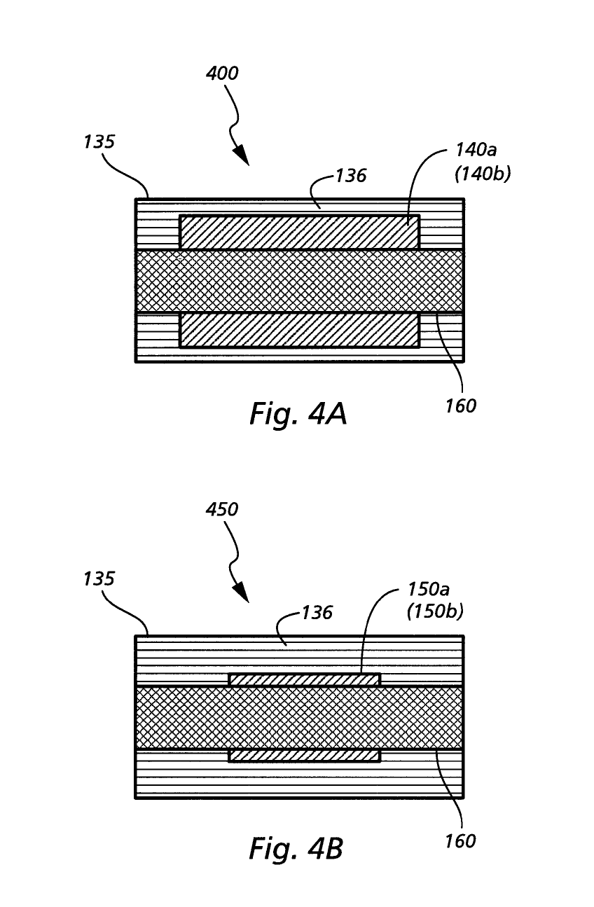

FIG. 4A illustrates portion 400 of motor stator core housing 135 periphery having at least one lamination 136. Portion 400 includes a conductive stay 140a, 140b being sandwiched (physically secured and thermally in contact) between conductive band 160 and motor stator core housing 135. The placement of the conductive stays 140a, 140b under the conductive band 160 and in contact with housing 135 permits additional channeling of thermal energy away from coils 115 and 120, thereby cooling those areas of motor 200 which tend to encounter heat stress. One or more stays, which may both use conductive material may be interposed between conductive band 160 and stator core housing periphery 137, at one or both of the peripheries 137 proximate to upper coil 115 and lower coil 120.

Similarly, FIG. 4B illustrates portion 450 of motor stator core housing 135 periphery having at least one lamination 136 in which a insulative stay 150a, 150b, which can be interposed between conductive band 160 and stator core housing periphery 137. Insulative stays 150a, 150b may or may not be used to suit the economics and pragmatic design issues faced by the motor designer and manufacturer. However, insulative stays 150a, 150b can be points of reduced thermal flow due to their location away from the coils, to which excessive heat from coils 115 or 120 can directed through conductive band 160.

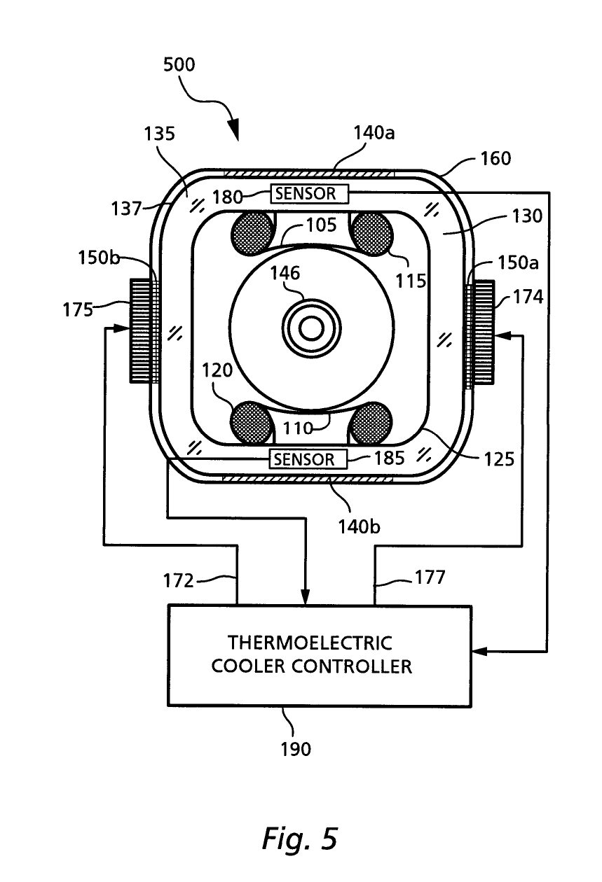

FIG. 5 depicts a thermo-regulated motor embodiment, generally at 500, which is a cross-section similar to section 300 of FIG. 3. In this example embodiment, conductive band 160 and conductive stays 140a, 140b are supplemented with thermoelectric coolers 174, 175 to further remove excess stator heat. FIG. 5 can include thermoelectric modules 174, 175 to further absorb excess heat from upper coil 115 and lower coil 120, and the regions including and around upper stanchion 105 and lower stanchion 110. In motor 500, thermal contact is made between the thermoelectric modules 174 and 175, and conductive stays 140a, 140b using conductive band 160. The conductive stays 140a, 140b typically are forced against motor stator core housing 135 in the vicinity of the stanchions 105, 110 and coils 115, 120. In general, insulative stays 150a, 150b are interposed between stator core housing periphery surface 137 and conductive band 160, beneath thermoelectric modules 174, 175, for convenience.

Direct positioning of thermoelectric modules 174, 175 over coils 115, 120 may be used, but also may cause thermal variations in the stator coil region, which may be deleterious. However, empirical analysis or thermal modeling may indicate direct placement of one or more thermoelectric coolers upon motor stator core housing 135 in other placement configurations may be desirable. Using insulative stays beneath the thermoelectric modules, buffers the cooling effect of modules 170, 175 directly upon the housing therebeneath, and directs the cooling effect of modules 170, 175 to conductive stays 140a, 140b and the regions immediately therearound.

One or more sensors 180, 185 may be placed in those areas most susceptible to overheating, that is, proximate to conductive stay 140a, 140b, respectively. Sensors 180, 185 may be disposed on the core or on a portion of motor stator core housing 135 not in direct contact with conductive band 160. In many cases, the frame or case temperature of a motor can exceed expected norms long after the motor windings (coils) have reach thermal peak, so sensors 180, 185 closest to the coils 115, 120 may be desirable to provide accurate readings of coil region temperatures. Signals from sensors 180, 185 may be received by thermoelectric cooler controller 190 which, in turn, sends signals 172, 177 to one or more of thermoelectric cooler modules 170, 175 in response to the motor heat. Thermoelectric coolers can be operated to run independently of the motor by responding to the motor heat, causing a motor to cool down to operating temperature much more quickly than a typically motor. In many cases, a duty cycle in excess of 25% can be obtained from a thermo-regulated motor system. Indeed, thermoelectric cooler modules may be stacked thermoelectric coolers, synergistically increasing the cooling properties of a single cooler. Of course, in view of the foregoing, multiple configurations of thermo-regulated motors may be drawn from thermo-regulated motor 500.

For example, in one embodiment, without thermoelectric coolers, conductive strap 160 can be made wider to mostly cover, or to nearly fully cover motor stator core housing 135 width. This embodiment may employ more than one conductive stay 140a, 140b to assist in dissipating excess heat from the motor. Conductive strap 160 can assist in relatively conveying heat to a thermoelectric cooler, even if just one cooler is employed. In yet another embodiment, no insulative stays 150a, 150b may be used but, instead, a plurality of conductive stays 140a, 140b may be interposed between the conductive band 160 and motor stator core housing 135.

In still another embodiment, a thermoelectric cooler may be placed atop an insulative stay 150a, or 150b, and about 90 degrees apart from conductive stays 140a, 140b. Sizing, placement and number of conductive stays 140a, 140b may be varied to compensate for “hot spots” anticipated through empirical analysis or determined through thermal modeling of the motor with section 500. Sensors such as sensors 180, 185 may be simple thermistor devices or solid state thermal feedback elements or other thermal-sensing devices, which may be used singly, or used in plurality, again as economics, empiricism, or modeling suggest. A sensor may not be used at all.

Thermoelectric coolers, including Peltier-effect devices, can be obtained from TEC Microsystems GmbH, Berlin, Del. as well as from TE Technology, Inc., Traverse City, Mich., USA. Tutorials and papers on designing TE coolers for a variety of purposes are widely available on the Internet. One example is Designing with Thermoelectric Coolers, available at URL: http://www.enertron-inc.com/enertron-resources/PDF/Designing-with-Thermoelectric-Coolers.pdf and at Thermoelectric Cooling at URL: http://en.wikipedia.org/wiki/Thermoelectric cooling, both on Jan. 23, 2012. A thermal fin or heat-dissipating fan, or both, may be used alone or in conjunction with thermoelectric coolers, and may be coupled to conductive band 160.

A conductive stay may be made of a material that is thermally conductive yet electrically insulative, for example, a piece of thermally conductive tape, epoxy, or paste. An insulative stay may be made of a material that is both electrically and thermally insulative, for example, insulative plastic, thermally insulative tape, ceramic, epoxy, or paste.

As suggested previously, a shredder with a thermo-regulated motor can produce a duty cycle having a longer “ON” time, which would allow more sheets of paper to be shredded per batch, a longer duty cycle, or both. For example, a thermo-regulated motor may have a duty cycle greater than about 25%.

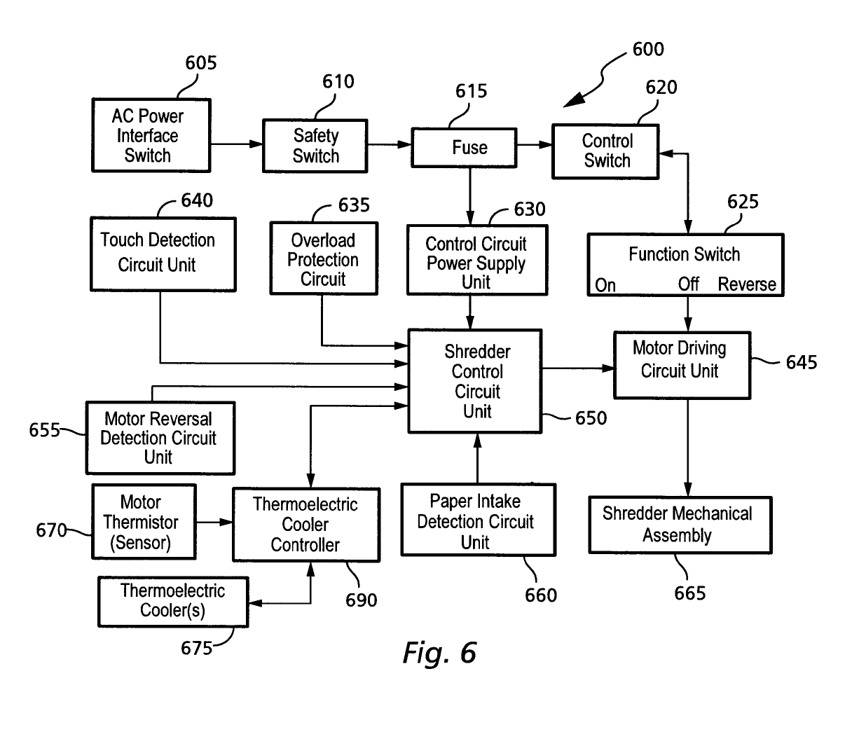

FIG. 6 illustrates a block diagram for a shredder motor controller 600 including AC power interface switch 605 coupled to safety switch 610 coupled to fuse, 615. Fuse 615 integrity provides power to control switch 620 and control circuit power supply (CCPS) unit 630. CCPS unit 630 provides power to shredder control circuit unit 650, which enables power to motor driving circuit unit 645. When so enabled, motor 200 may be capable of being powered on by control switch 620 and being manipulated (ON/OFF/REVERSE) by function switch 625.

When motor driving unit 645 is enabled, motor 200 (not shown), electromechanically coupled to shredder mechanical assembly 665, operates to comminute or to reverse shreddant from the comminution path. Safety and protection features also include touch detection circuit 640, such as a bioelectricity-sensing circuit, overload protection circuit 635, paper intake detection circuit 660 to cycle shredder on/off while enabled in response to sensing shreddant presence in the shredder intake circuit, and motor reversal detection circuit 655. Overload protection circuit 635 typically trips when a thermal peak indicating the end of a duty cycle ON period has been reached. Once the motor has cooled to an acceptable operating temperature (e.g., ambient temperature), then overload protection circuit is disposed to permit operation of motor 200. To provide thermo-regulation of motor 200, motor sensor 670 can detect a changing temperature in the stator housing (or wherever the sensor is located) which, in turn, may cause thermoelectric cooler controller 690 to activate thermoelectric coolers 675. Activation of thermoelectric coolers 675 can be before, during, or after activation of motor 200 (not shown). Post-shutdown cooling of the motor 200 can allow a more rapid return to standard ambient temperatures, allowing a more rapid return-to-service, and shortening of the OFF portion of the duty cycle. This condition allows more pieces of paper to be shredded per unit time, i.e., more pieces shredded per duty cycle.

The embodiments of the present invention disclosed herein are intended to be illustrative only, and are not intended to limit the scope of the invention. It should be understood by those skilled in the art that various modifications and adaptations of the prevent invention as well as alternative embodiments of the prevent invention may be contemplated or foreseeable. It is to be understood that the present invention is not limited to the sole embodiments described above, but encompasses any and all embodiments within the scope of the following claims.

1. A paper shredder, comprising:
a shredder mechanical assembly configured to comminute sheets of paper; and
a thermo-regulated motor with a motor stator core housing, the thermo-regulated motor coupled to the shredder mechanical assembly and configured to urge the shredder mechanical assembly to comminute the sheets of paper, wherein the thermo-regulated motor includes at least one thermal conductive stay secured to the periphery of the motor stator core housing with a thermal conductive band and wherein the thermal conductive band and thermal conductive stay act to dissipate motor thermal heat.

2. The paper shredder of claim 1, further comprising:
a thermoelectric cooler thermally coupled to the thermal conductive band.

3. The paper shredder of claim 2, further comprising:
a thermal insulative stay secured to the motor stator core housing with a thermal conductive band and set apart from the thermal conductive stay.

4. The paper shredder of claim 3, further comprising:
a plurality of thermal conductive stays secured to the motor stator core housing with a thermal conductive band and set apart from the thermal insulative stay.

5. The paper shredder of claim 1, further comprising:
a plurality of the thermal insulative stays;
a plurality of the thermal conductive stays set apart from the thermal insulative stays,
wherein the plurality of thermal insulative stays and the plurality of thermal conductive stays are secured to the motor stator core housing with the thermal conductive band to dissipate motor thermal heat.

6. The paper shredder of claim 5, further comprising:
a thermoelectric cooler thermally coupled to the thermal conductive band to provide cooling to the motor stator core housing, and
a theremoelectric cooler controller coupled to the thermoelectric cooler and configured to vary cooling provided by the thermoelectric cooler to the motor stator core housing in response to motor thermal heat, a motor load, or both.

7. The paper shredder of claim 2, further comprising:
a plurality of thermoelectric coolers; and
a thermoelectric cooler controller coupled to the plurality of thermoelectric coolers and configured to vary cooling provided by the plurality of thermoelectric coolers to the motor stator core housing in response to motor thermal heat.

8. The paper shredder of claim 6, further comprising:
a plurality of thermoelectric coolers; and
a thermoelectric cooler controller coupled to the plurality of thermoelectric coolers and configured to vary cooling provided by the plurality of thermoelectric coolers to the motor stator core housing in response to motor thermal heat.

9. The paper shredder of claim 6, further comprising:
at least one thermal sensor coupled to the thermoelectric cooler controller and to the motor stator core housing to transmit a motor thermal heat signal representative of heat in the motor stator core housing to the thermoelectric cooler controller.

10. The paper shredder of claim 8, wherein the thermoelectric cooler has a heat-dissipating side and wherein at least one of the plurality of thermoelectric coolers has a thermal fin thermally coupled to the respective heat-dissipating side.

11. The paper shredder of claim 9, wherein the thermo-regulated motor has a duty cycle of at least 25%.

12. The paper shredder of claim 9 wherein the thermoelectric cooler continues to cool the motor stator core housing after the motor is deenergized.

13. The paper shredder of claim 12, wherein the thermo-regulated motor has a duty cycle of at least 25%.

14. The paper shredder of claim 11, further comprising an activation circuit, coupled to a thermo-regulated motor and disposed to activate the thermo-regulated motor in the presence of shreddant.

15. The paper shredder of claim 14, further comprising a power regulation circuit, coupled to and disposed to regulate power to at least one of the thermo-regulated motor, the shredder controller, and the thermoelectric cooler controller.

16. The paper shredder of claim 9 wherein the motor is operated by one of an alternating current or a direct current.

17. A universal motor, comprising:
a motor rotor;
a motor stator core housing enclosing the rotor;
at least two coils of wires in opposition to the other and, when energized, electromechanically active on the motor rotor;
at least two set apart thermally conductive stays thermally coupled to the motor stator core housing;
at least two set apart thermally insulative stays physically coupled to the motor stator core housing alternatingly in-between the at least two set apart thermally conductive stays; and
at least one conductive band securing the insulative stays to and thermally coupling the conductive stays to the motor stator core housing.

18. The motor of claim 17, further comprising:
a plurality of thermoelectric coolers secured and thermally coupled on the at least one conductive band and respectively disposed in the proximity of the at least two set apart thermally insulative stays.

19. A method for cooling a motor, comprising:
providing a thermal conductive band around a motor stator core housing;
providing a thermal conductive stay thermally interposed between the thermal conductive band and the motor stator core housing;
providing a thermal insulative stay thermally interposed between the thermal conductive band and the motor stator core housing and set apart from the thermal conductive stay; and
providing cooling to the motor stator core housing by heat conduction with the thermal conductive band and the thermal conductive stay thermally interposed thereinbetween.

20. The method of claim 19, further comprising:
providing a thermoelectric cooler on the conductive band in proximity to the thermal insulative stay;
sensing a motor stator core housing temperature; and
controlling in response motor stator core housing temperature by operating the thermoelectric cooler thermally coupled to the thermally conductive band thermally coupled to the thermally conductive stays.

21. A cooled motor, comprising:
means for providing a thermal conductive band around a motor stator core housing;
means for providing a thermal conductive stay thermally interposed between the thermal conductive band and the motor stator core housing;
means for providing a thermal insulative stay thermally interposed between the thermal conductive band and the motor stator core housing and set apart from the thermal conductive stay;
means for providing cooling to the motor stator core housing by heat conduction with the thermal conductive band and the thermal conductive stay thermally interposed thereinbetween;
means for providing a thermoelectric cooler on the conductive band in proximity with the thermal insulative stay;
means for sensing a motor stator core housing temperature; and
means for controlling in response motor stator core housing temperature by operating the thermoelectric cooler thermally coupled to the thermally conductive band thermally coupled to the thermally conductive stays.
